(19) United States
(12) Patent Application Publication
(10) Pub. No.: US 2020/0292190 A1
(43) Pub. Date: Sep. 17, 2020

(54) SYSTEMS AND METHODS FOR PRIMARY AND SECONDARY TEMPERATURE CONTROL

(71) Applicant: JOHNSON CONTROLS TECHNOLOGY COMPANY, Auburn Hills, MI (US)

(72) Inventors: Theresa N. GILLETTE, Wichita, KS (US); Andrew Michael BOYD, Wichita, KS (US); Thomas D. CHASE, Rose Hill, KS (US); Madhuka Manuranga JAYARATHNE, Wichita, KS (US)

(21) Appl. No.: 16/591,220

(22) Filed: Oct. 2, 2019

Related U.S. Application Data
(60) Provisional application No. 62/817,835, filed on Mar. 13, 2019.

(51) Int. Cl. F24F 11/30; F24F 11/54; F24F 11/56; F24F 11/64; F24F 11/67; G05B 15/02

(52) U.S. Cl. CPC F24F 11/30; F24F 11/54; F24F 11/56; F24F 2110/10; F24F 11/67; G05B 15/02; F24F 11/64

(57) ABSTRACT

A temperature control system receives, from a remote user device associated with a user, a user designation designating a temperature sensor from among a plurality of temperature sensors. The temperature control system selects, in response to receiving the user designation, the temperature sensor as a primary temperature sensor for controlling an ambient condition. The temperature control system receives a primary temperature measurement from the primary temperature sensor, and performs a primary temperature control based on the primary temperature measurement. The temperature control system may further receive secondary temperature measurements from secondary temperature sensors, and perform a secondary temperature control based on the secondary temperature measurements.

### CROSS REFERENCE TO RELATED APPLICATION(S)

This application claims the benefit of U.S. Provisional Application Ser. No. 62/817,835, entitled “SYSTEMS AND METHODS FOR PRIMARY AND SECONDARY TEMPERATURE CONTROL” and filed on Mar. 13, 2019, which is expressly incorporated by reference herein in its entirety.

### BACKGROUND

The present disclosure relates generally to temperature control, and more specifically to temperature control for a heating, ventilation, and air conditioning (HVAC) system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure provides temperature control systems, apparatuses, and methods.

In an aspect, a temperature control apparatus includes a processor and a memory coupled with the processor and storing instructions. The instructions, when executed by the processor, cause the processor to receive, from a remote user device associated with a user, a user designation designating a temperature sensor from among a plurality of temperature sensors. The instructions, when executed by the processor, further cause the processor to select, in response to receiving the user designation, the temperature sensor as a primary temperature sensor for controlling an ambient condition. The instructions, when executed by the processor, further cause the processor to receive a primary temperature measurement from the primary temperature sensor. The instructions, when executed by the processor, further cause the processor to perform a primary temperature control based on the primary temperature measurement.

In another aspect, a temperature control method may include receiving, from a remote user device associated with a user, a user designation designating a temperature sensor from among a plurality of temperature sensors. The temperature control method further includes selecting, in response to receiving the user designation, the temperature sensor as a primary temperature sensor for controlling an ambient condition. The temperature control method further includes receiving a primary temperature measurement from the primary temperature sensor. The temperature control method further includes performing a primary temperature control based on the primary temperature measurement.

In a further aspect, a non-transitory computer-readable medium stores instructions that, when executed by a processor, cause the processor to perform temperature control. The instructions, when executed by the processor, cause the processor to receive, from a remote user device associated with a user, a user designation designating a temperature sensor from among a plurality of temperature sensors. The instructions, when executed by the processor, further cause the processor to select, in response to receiving the user designation, the temperature sensor as a primary temperature sensor for controlling an ambient condition. The instructions, when executed by the processor, further cause the processor to receive a primary temperature measurement from the primary temperature sensor. The instructions, when executed by the processor, further cause the processor to perform a primary temperature control based on the primary temperature measurement.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an example HVAC system, according to aspects of the present disclosure;

FIG. 2 is a block diagram of the example temperature control system for the HVAC system of FIG. 1, according to aspects of the present disclosure;

FIG. 3 is a block diagram of an example computing device which may implement a component in the example temperature control systems of FIG. 1 or 2, according to aspects of the present disclosure; and

FIG. 4 is a flow diagram of an example temperature control method, according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure provide apparatuses, methods, and systems that allow for improved temperature control initially based on one or more temperature measurements received from a primary temperature sensor and later based on temperature measurements subsequently received from one or more secondary temperature sensors. In an aspect, for example, temperature control may be performed based on how the readings of a primary temperature sensor compare with a primary setpoint, and after a certain period of time, further/supplemental temperature control may be performed based on how the readings of the one or more secondary temperature sensors compare with a secondary setpoint.

In an aspect, for example, the temperature in various spaces in a multi-level structure such as a house or building may not be consistent throughout the house or building. For example, the basement of a multi-level house may be the coolest area in the house, while the upper floor may be the warmest area in the house. Some aspects may perform temperature control in a multi-level house by using a thermostat located in the main floor of the house, for example, in a main floor living room, to keep the main floor at a desired temperature. However, the basement of the house may still be cooler than desired, and the second floor of the house may be warmer than desired. In contrast, some aspects allow for a homeowner to add/install multiple wireless remote temperature sensors throughout a multi-level house to achieve more consistent temperature control throughout various areas/spaces that may be occupied by occupants of the house at different times.

In an aspect, for example, multiple temperature sensors may be installed and activated throughout a house, and a homeowner may apply temperature control customization based on when each space in the house is occupied. The customization may be applied/configured, for example, on a thermostat, on an application on a mobile device, etc. In an aspect, for example, temperature measurements of remote temperature sensors may be averaged across all active remote temperature sensors in the house, and the average temperature may be used for temperature control of the house. Alternatively, a homeowner may configure the temperature control to be performed based on the temperature measurements of a specific temperature sensor, such as a temperature sensor installed in a bedroom.

For example, in an aspect, a homeowner may choose not to implement temperature control based on an average of the temperature measurements made by multiple temperature sensors installed throughout a house. Instead, the homeowner may give priority to certain temperature sensors at certain periods during the day, on certain days of the week, etc. For example, during the day on the weekends, all sensor measurements may be averaged, since the house occupants may be spread out throughout the house. However, in the evenings, priority may be given to a temperature sensor installed in the kitchen, and temperature control may be implemented based on the measurements of the kitchen temperature sensor, since the kitchen is where the house occupants are most likely to be in the evening. Similarly, at night, temperature control may be implemented based on the measurements of a temperature sensor installed in a bedroom.

In a further aspect, for example, an occupancy sensor, such as a camera, a microphone, a proximity sensor, etc., may automatically detect the presence of one or more occupants in a certain area/zone in a house or building. In response to detecting occupants in an area/zone in a house or building, priority may be given to one or more temperature sensors installed in such areas/zones, and temperature control may be implemented based on the measurements of the one or more temperature sensors in such areas/zones.

In one non-limiting aspect, for example, priority and occupancy settings may be available as independent settings on one or more sensors/sub systems, either as a manual or as an automated setting. In an aspect, based on signals received from the sensors back to an HVAC system, the HVAC system may determine which sensor has priority and which sensors are in occupied spaces. In an aspect, a homeowner may configure which area of the house should have priority. In an aspect, the sensors reside outside the controller of the HVAC system and communicate with the controller. In one non-limiting aspect, for example, the homeowner may configure a sensor to be associated with a set of air baffles, and may control which areas of the house needs to be cooled or heated. As such, the homeowner may configure “zoning” across the house for performing temperature control.

For example, in an aspect, there may be three occupancy sensors in a house, including a sensor in a living room, a sensor in a bedroom, and a sensor in a basement, and each of the three sensors may be capable of sensing occupancy, i.e., sensing the presence of people/occupants in a room. In an aspect, for example, when a person is in the basement, the presence of the person may activate an occupancy sensor in the basement, and when the person moves from the basement to the living room, an occupancy sensor in the living room may be activated. In an aspect, when there are multiple people present in multiple rooms of a house, multiple respective occupancy sensors may indicate to the HVAC system that such rooms are occupied. In response, the HVAC system may try to perform temperature control based on the measurements of one or more temperature sensors in the rooms/areas/zones where occupancy is detected.

However, each of the sensors in the living room, bedroom, and basement may also have a priority setting, and the HVAC system may allow for only one sensor to have priority for temperature control. For example, in an aspect, a homeowner may set the sensor in the living room to have priority for temperature control. The homeowner may further configure a 78 degree setpoint for the living room, and a 74 degree setpoint for the other rooms. Since the living room is set to have priority for temperature control, the HVAC system may ignore the occupancy information associated with the non-priority occupancy sensors, and may try to reach the 78 degree setpoint of the living room, whether the living room or any other rooms are indicated as being occupied or not.

In one non-limiting aspect, for example, priority and occupancy settings may be available via an HVAC application on a remote user device, such as a mobile phone, of a person/occupant in the house. In this case, the mobile phone may communicate priority and/or occupancy settings to the HVAC system to indicate where a person is, and the HVAC system may perform temperature control accordingly so as to provide comfort for the person. Similarly, a home virtual assistant tied to a sensor may be configured to have priority for temperature control, i.e., the HVAC system may perform temperature control based on the sensor associated with and/or communicatively coupled with the home virtual assistant.

In an aspect, for example, the HVAC system may not be able to continue temperature control based on an occupancy or priority sensor, for example, when an activated occupancy sensor or a sensor set to have priority is no longer operable, e.g., due to communication failure, dead battery, etc. In this case, the HVAC system may revert to a last setting defined by a user and perform temperature control based on a return air temperature. For example, in an aspect, if the return air temperature is 76 degrees, and the last user setting before the failure was 72 degrees, the HVAC system may use 72 degrees as the target setpoint temperature, use the 76 degree return air temperature as the current condition, and start cooling the home.

In an aspect, if the HVAC system determines that a signal is no longer being received from a sensor, the HVAC system may issue a warning to the user, e.g., a text message, email, or a warning via an HVAC application on a remote user device, to examine that particular sensor. In the meantime, the HVAC system may default to use the return air temperature in place of the temperature measurements of the failed sensor.

In one non-limiting aspect, for example, the homeowner may designate a succession of priorities for multiple sensors, and the HVAC system may perform temperature control according to the operability/availability of the sensors and the order of priority. For example, if the highest priority sensor is not operable or available, the HVAC system may perform temperature control based on temperature measurements received from the next highest priority, and so on. In a further aspect, the order of priority may be used to achieve the setpoint in each zone/area successively. For example, the HVAC system may first perform temperature control based on temperature measurements received from the highest priority sensor. After achieving a desired temperature in the highest priority area, the HVAC system may perform temperature control to achieve a desired temperature in a second highest priority area/zone, and so on.

Accordingly, in an aspect, multiple remote temperature sensors may be installed throughout the house to allow a homeowner to implement temperature control based on the lifestyle of the house occupants to make the house occupants comfortable in each space that is occupied at each time of the day, at each day of the week, etc. Alternatively and/or additionally, the remote temperature sensors may allow for implementing temperature control that provides improved overall comfort in the house when moving from one space to another space. For example, in temperature control systems that perform temperature control using only a thermostat on the main floor of a multi-level house, a homeowner may feel a temperature difference when going from the second floor to the basement during the winter, e.g., a temperature difference of 4 to 5 degrees Fahrenheit. However, installing and using multiple remote temperature sensors in different areas of such a multi-level house may allow for reducing such temperature difference down to, for example, 2 or 3 degrees Fahrenheit.

Turning now to the figures, example aspects are depicted with reference to one or more components described herein, where components in dashed lines may be optional.

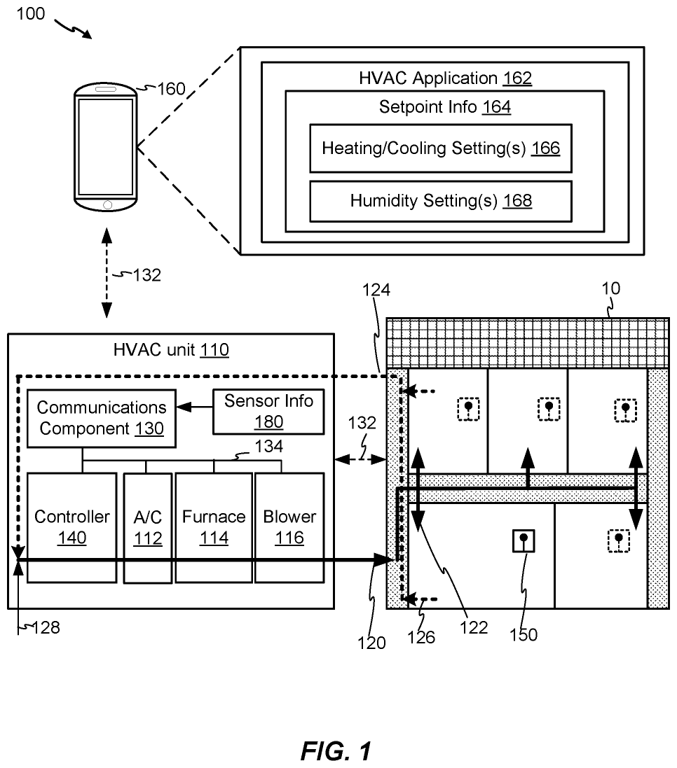

Referring to FIG. 1, an HVAC system 100 for a building 10 is disclosed. The HVAC system 100 may include an HVAC unit 110 configured to control an ambient condition of the one or more rooms of the building 10 based on information from one or more sensors 150 and a remote user device 160. In an example, an ambient condition may be a temperature or a humidity level. As shown by FIG. 1, the HVAC unit 110 may be external to the building 10. In an aspect, one or more components (e.g., air conditioning (A/C) unit 112, furnace 114, blower 116, heat pump (not shown), communications component 130, or controller 140) may be located in different locations including inside the building 10. The building may be a home, office or any other structure that includes an HVAC system for controlling one or more ambient conditions of the structure.

In an aspect, the HVAC system 100 may include supply ducts 120 and return ducts 124 installed within the building 10 and coupled with the HVAC unit 110. The supply ducts 120 may supply air to the building 10, and the return ducts 124 may return air from the building 10. The supply ducts 120 may receive supply air through one or more of intakes 128 that provide outside air to the HVAC system 100 or may recycle return air from the return ducts 124. The supply ducts 120 may output the supply air at one or more of the rooms of the building 10 via one or more supply vents 122. The return ducts 124 may receive return air from the building 10 via the return ducts 124 to balance air within the building 10. The return air may be input into the return ducts 124 via one or more return vents 126.

The HVAC unit 110 may include one or more of an air conditioning (A/C) unit 112, a furnace 114, a blower 116, a humidifier, a dehumidifier, a heat pump, or any other components for adjusting an ambient condition of a room of the building 10. The A/C unit 112 may be configured to cool the supply air by passing the supply air through or around one or more cooled pipes (e.g., chiller pipes) to lower a temperature of the supply air. The furnace 114 may be configured to warm the supply air by passing the supply air through or around one or more warmed pipes (e.g., heating coils) to raise a temperature of the supply air. The blower 116 may be configured to blow the supply air through the supply ducts 120 to the building 10 and pull the return air from the building 10. The humidifier may be configured to add moisture to the supply air. The dehumidifier may be configured to reduce moisture in the supply air.

The HVAC unit 110 may also include a communications component 130 configured to communicate with the one or more sensors 150 and/or the remote user device 160. In an aspect, the communications component 130 may communicate with the one or more sensors 150 and/or the remote user device 160 via one or more communications links 132. In an example, the communications component 130 may include one or more antennas, processors, modems, radio frequency components, and/or circuitry for communicating with the sensor 150 and/or the remote user device 160. The one or more communications links 132 may be wired or wireless communication links.

The HVAC system 100 may also include the one or more sensors 150 located within one or more rooms of the building 10 and/or within or near the supply vents 122. One or more sensors 150 may be configured to detect an ambient condition such as a temperature or a humidity level of the room where the sensor 150 is located. Each of the sensors 150 may provide sensor information 180 to the HVAC unit 110. Examples of a sensor 150 may include a temperature sensor, a humidity sensor, or any sensor configured to detect an ambient condition of one or more rooms of the building 10.

The HVAC system 100 may also include the remote user device 160 configured to communicate with the HVAC unit 110. The remote user device 160 may include an HVAC application 162 configured to allow a user of the remote user device 160 to control an ambient condition (e.g., a temperature) via the HVAC system 100—with or without a wall mounted interface. For example, in one non-limiting aspect, the HVAC application 162 may supplement and/or substitute the functionality of a wall mounted thermostat. For example, in an aspect, the HVAC application 162 may allow a user of the remote user device 160 to partially and/or fully control the operation of the HVAC system 100, e.g., by communicating with the controller 140 of the HVAC unit 110. In an aspect, for example, the user may use the remote user device 160 to adjust/select one or more user priorities/preferences that cause the controller 140 to control one or more of the AC unit 112, the furnace 114, the blower 116, the humidifier, the dehumidifier, the heat pump, or any other components for adjusting an ambient condition of a room of the building 10. Accordingly, the HVAC system 100 may operate according to instructions/settings received from the remote user device 160 and without the need for a wall mounted interface/thermostat.

In an aspect, for example, the HVAC application 162 may be configured to display, adjust, and store setpoint information (“info”) 164 indicating desired user settings for one or more rooms of the building 10. In an example, the setpoint information 164 may include heating/cooling settings 166 indicating one or more desired temperatures (e.g., minimum and/or maximum room temperatures) for one or more rooms of the building and/or humidity settings 168 indicating a desired humidity level for one or more rooms of the building 10. The remote user device 160 may provide the setpoint information 164 to the HVAC unit 110. Examples of a remote user device 160 may include a mobile device, a cellular phone, a smart phone, a personal digital assistant (PDA), a smart speaker, a home assistant, a wireless modem, a wireless communication device, a handheld device, a tablet computer, a laptop computer, a cordless phone, a smart watch, an entertainment device, an Internet of Things (IoT) device, or any device capable of communicating with the HVAC unit 110. A smart speaker may include, for example, an Echo® device available from Amazon, Inc. of Seattle, Wash., a Google Home® device available from Google, Inc. of Mountain View, Calif., or other similar devices. The HVAC application 162 may include a voice interface that response to voice commands.

The HVAC unit 110 may also include a controller 140 configured to control the A/C unit 112, the furnace 114, the blower 116, the humidifier, and the dehumidifier based on the sensor information 180 received from the sensor 150 and the setpoint information 164 received from the remote user device 160. The controller may communicate with the communications component 130, the A/C unit 112, the furnace 114, the blower 116, the humidifier, and/or the dehumidifier via a communications bus 134. The controller 140 may include logic to determine when to initiate the blower 116 along with one of the A/C unit 112 or the furnace 114 based on the sensor information 180 and the setpoint information 164. The controller 140 may also include logic to determine a time and/or a speed to run the blower 116 along with a time or power level to run one of the A/C unit 112 or the furnace 114 based on the sensor information 180 and the setpoint information 164.

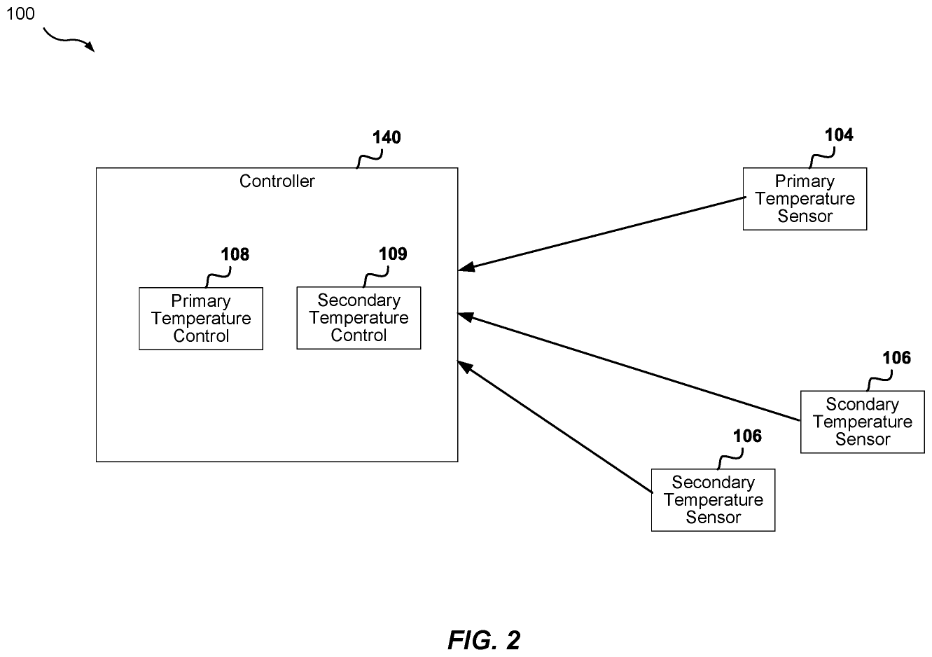

Referring to FIG. 2, in one non-limiting aspect, the controller 140 in the HVAC system 100 may perform primary temperature control 108 based on temperature measurements received from a primary temperature sensor 104, and subsequently performs secondary temperature control 109 based on temperature measurements received from one or more secondary temperature sensors 106. For example, in an aspect, when the controller 140 is turned on, the controller 140 may first identify the primary temperature sensor 104 based on pre-configured or user-defined priorities indicating which one of multiple available temperatures sensors should be selected for performing the primary temperature control 108. The controller 140 then performs the primary temperature control 108 based on one or more temperature measurements received from the identified primary temperature sensor 104. In an aspect, for example, the primary temperature sensor 104 may be, for example, a temperature sensor installed on a main floor in a multi-level house, e.g., a temperature sensor in the living room.

Subsequently, the controller 140 may receive temperature measurements from one or more secondary temperature sensors 106, which may be, for example, further temperature sensors installed in the basement or in the top floor of the multi-level house. In an aspect, for example, based on pre-configured or automatic settings, the controller 140 may calculate a function, such as an average, of the measurements of the secondary temperature sensors 106 over a period of time. For example, in an aspect, the controller 140 may calculate the function based on measurements of the secondary temperature sensors 106 received over a one or ten minute period since starting the primary temperature control 108. Then, the controller 140 may perform the secondary temperature control 109 based on the calculated function of the measurements of the secondary temperature sensors 106.

Accordingly, in cases where the primary temperature sensor 104 and the secondary temperature sensors 106 indicate very different measurements at the time the controller 140 is turned on, the controller 140 may achieve better control of the HVAC system 100 by initially running the primary temperature control 108 based on the temperatures measurements of the primary temperature sensor 104, and after a period of time has elapsed, switching to perform the secondary temperature control 109 based on temperature measurements of the secondary temperature sensors 106.

Optionally, in an aspect, the temperature measurements received from a temperature sensor, such as the primary temperature sensor 104 or the secondary temperature sensors 106, may be used to control the air flow to a corresponding area in the house where that temperature sensor is installed. For example, in an aspect, the controller 140 may cause the HVAC system 100 to direct more air flow to a certain area in the building 10 if a sensor installed in that area indicates that such an area requires further air flow to reach a desired temperature.

In an aspect, for example, installing and using multiple temperature sensors, such as the primary temperature sensor 104 or the one or more secondary temperature sensors 106, may provide redundancy. For example, in some aspects, a temperature sensor may go down, or the battery of a temperature sensor may die, or a wireless fidelity (WiFi) connection to a wireless temperature sensor may be lost, etc. In these cases, even when one or more temperature sensors are down or otherwise unavailable, the controller 140 may use a calculated average of the measurements of multiple temperature sensors to continue to perform temperature control in the HVAC system 100.

Optionally, the primary temperature control 108, the secondary temperature control 109, or both of the primary temperature control 108 and the secondary temperature control 109 may include only one stage or multiple stage operations. For example, a single stage temperature control may include operating the A/C unit 112 or the furnace 114 at either zero or full power level, and/or operating the blower 116 at either zero or full speed. However, in a multi stage temperature control, the controller 140 may further operate the A/C unit 112 or the furnace 114 at less than full power level and/or may operate the blower 116 at less than full speed, such as running slow or at a low revolutions per minute (RPM), to consume less electricity. In some aspects, for example, such a low power or speed may be sufficient for controlling the temperature of a house, and the controller 140 may not need to run the furnace 114 or the A/C unit 112 at full power and/or run the blower 116 at full speed. Alternatively, in an aspect, for example, when there is a large difference between the temperature measurements received by the controller 140 and the corresponding setpoints for a desired temperature, the controller 140 may operate one or more of the furnace 114, the A/C unit 112, the blower 116, or the heat pump (not shown) at another stage with a higher power or speed. Subsequently, when the temperature measurements received by the controller 140 get closer to the corresponding setpoints, the controller 140 may operate one or more of the furnace 114, the A/C unit 112, the blower 116, or the heat pump (not shown) at a lower power or speed. In some aspects, implementing such a multi stage temperature control may result in varying electricity consumption by the HVAC system 100, and may result in conserving electric power.

In an aspect, for example, the controller 140 may implement a multi stage temperature control including a first stage in which the A/C unit 112 or the furnace 114 are operated at full power level, and/or the blower 116 is operated at full speed. Then, when the temperature measurements reach a certain threshold, the controller 140 may switch to a second stage in which the A/C unit 112 or the furnace 114 are operated at a lower power level, and/or the blower 116 is operated at a lower speed. Subsequently, when the system gets to another threshold (within 1 degree from reaching a setpoint), the controller 140 may switch to a third stage where one or more of the A/C unit 112, the furnace 114, the blower 116, or the heat pump (not shown) are shut down with the expectation being that the temperature will continue to rise or lower to the desired temperature.

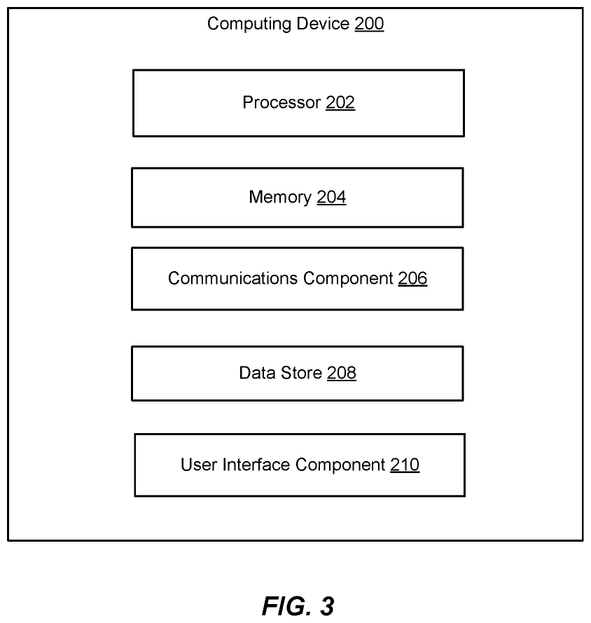

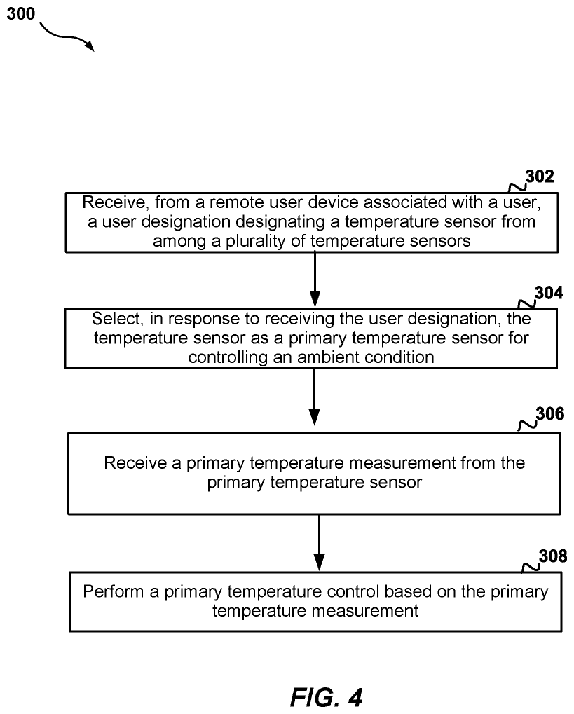

Referring to FIG. 3, a computing device 200 may implement all or a portion of the functionality described in FIGS. 1 and 2 above or described in FIG. 4 below. For example, the computing device 200 may be or may include at least a portion of the remote user device 160, the controller 140, or any other component described herein with reference to FIGS. 1 and 2 above. The computing device 200 includes a processor 202 which may be configured to execute or implement software, hardware, and/or firmware modules that perform some or all of the functionality described herein with reference to FIGS. 1 and 2 above or with reference to FIG. 4 below. For example, the processor 202 may be configured to execute or implement software, hardware, and/or firmware modules that perform some or all of the functionality described herein with reference to the HVAC system 100, the remote user device 160, the controller 140, the HVAC application 162, or any other component/system/device described herein with reference to FIGS. 1 and 2 above.

The processor 202 may be a micro-controller, an application-specific integrated circuit (ASIC), or a field-programmable gate array (FPGA), and/or may include a single or multiple set of processors or multi-core processors. Moreover, the processor 202 may be implemented as an integrated processing system and/or a distributed processing system. The computing device 200 may further include a memory 204, such as for storing local versions of applications being executed by the processor 202, related instructions, parameters, etc. The memory 204 may include a type of memory usable by a computer, such as random access memory (RAM), read only memory (ROM), tapes, magnetic discs, optical discs, volatile memory, non-volatile memory, and any combination thereof. Additionally, the processor 202 and the memory 204 may include and execute an operating system executing on the processor 202, one or more applications, display drivers, etc., and/or other components of the computing device 200.

Further, the computing device 200 may include a communications component 206 that provides for establishing and maintaining communications with one or more other devices, parties, entities, etc. utilizing hardware, software, and services. The communications component 206 may carry communications between components on the computing device 200, as well as between the computing device 200 and external devices, such as devices located across a communications network and/or devices serially or locally connected to the computing device 200. In an aspect, for example, the communications component 206 may include one or more buses, and may further include transmit chain components and receive chain components associated with a wireless or wired transmitter and receiver, respectively, operable for interfacing with external devices.

Additionally, the computing device 200 may include a data store 208, which can be any suitable combination of hardware and/or software, that provides for mass storage of information, databases, and programs. For example, the data store 208 may be or may include a data repository for applications and/or related parameters not currently being executed by processor 202. In addition, the data store 208 may be a data repository for an operating system, application, display driver, etc., executing on the processor 202, and/or one or more other components of the computing device 200.

The computing device 200 may also include a user interface component 210 operable to receive inputs from a user of the computing device 200 and further operable to generate outputs for presentation to the user (e.g., via a display interface to a display device). The user interface component 210 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 210 may include one or more output devices, including but not limited to a display interface, a speaker, a haptic feedback mechanism, a printer, any other mechanism capable of presenting an output to a user, or any combination thereof.

FIG. 4 is a flowchart of a method 300 of operation of the computing device 200. The method 300 may implement the functionality described herein with reference to FIGS. 1-3 above, and may be performed by one or more components of the computing device 200 or the controller 140 as described herein with reference to FIGS. 1-3 above.

At 302 the method 300 includes receiving, from a remote user device associated with a user, a user designation designating a temperature sensor from among a plurality of temperature sensors. For example, in an aspect, the controller 140 in the HVAC system 100 may receive, from the HVAC application 162 installed on the remote user device 160 which may be associated with a user, a user designation designating a temperature sensor from among a plurality of temperature sensors, and may select the designated temperature sensor as a primary temperature sensor 104. In an aspect, for example, the HVAC application 162 may be configured to allow the user of the remote user device 160 to control a temperature—with or without a wall mounted interface.

At 304 the method 300 further includes selecting, in response to receiving the user designation, the temperature sensor as a primary temperature sensor for controlling an ambient condition. For example, in an aspect, in response to receiving the user designation, the controller 140 may select the temperature sensor designated via the HVAC application 162 as the primary temperature sensor 104.

At 306 the method 300 further includes receiving a primary temperature measurement from a primary temperature sensor. For example, in an aspect, the controller 140 in the HVAC system 100 may receive a primary temperature measurement from the primary temperature sensor 104.

At 308 the method 300 further includes performing a primary temperature control based on the primary temperature measurement. For example, in an aspect, the controller 140 may perform the primary temperature control 108 based on the primary temperature measurement.

Optionally, in an aspect, the controller 140 may further receive one or more secondary temperature measurements from one or more secondary temperature sensors 106. For example, in an aspect, after starting the primary temperature control 108, the controller 140 may receive one or more secondary temperature measurements from one or more secondary temperature sensors 106 over a period of time, for example, over a 1 or 10 minute period after starting the primary temperature control 108.

Optionally, in an aspect, the controller 140 may perform the secondary temperature control 109 based on the one or more secondary temperature measurements.

Optionally, in an aspect, the controller 140 may further receive current timing information for performing the primary temperature control 108. In these aspects, the controller 140. In this case, selection of the primary temperature sensor 104 may be further based on the current timing information. Optionally, the current timing information may include at least one of a current time of day and/or a current day of week.

Optionally, in an aspect, the controller 140 may perform the primary temperature control 108 based on the primary temperature measurement by comparing the primary temperature measurement with a primary setpoint, and performing a single stage control of one or more of the furnace 114, the A/C unit 112, a heat pump, or the blower 116 based on the comparing.

In an aspect, for example, the single stage control may include turning one or more of the furnace 114, the heat pump, or the blower 116 on in response to the primary temperature measurement being less than the primary setpoint beyond a low threshold. The single stage control may further include turning one or more of the furnace 114, the heat pump, or the blower 116 off in response to the primary temperature measurement being within a high threshold of the primary setpoint.

In another aspect, for example, the single stage control may include turning one or more of the A/C unit 112, the heat pump, or the blower 116 on in response to the primary temperature measurement being greater than the primary setpoint beyond a high threshold. The single stage control may further include turning one or more of the A/C unit 112, the heat pump, or the blower 116 off in response to the primary temperature measurement being within a low threshold of the primary setpoint.

Optionally, in an aspect, the controller 140 may perform the primary temperature control 108 by performing a multi stage control.

In an aspect, for example, the multi stage control may include operating one or more of the furnace 114, the heat pump, or the blower 116 at a first power level and/or speed in response to a difference between the primary temperature and the primary setpoint being greater than a first threshold. The multi stage control may further include operating one or more of the furnace 114, the heat pump, or the blower 116 at a second power level or speed lower than the first power level and/or speed in response to the difference between the primary temperature and the primary setpoint being less than the first threshold but greater than a second threshold. The multi stage control may further include turning one or more of the furnace 114, the heat pump, or the blower 116 off in response to the difference between the primary temperature and the primary setpoint being less than the second threshold.

In an alternative aspect, for example, the multi stage control may include operating one or more of the A/C unit 112, the heat pump, or the blower 116 at a first power level and/or speed in response to a difference between the primary temperature and the primary setpoint being greater than a first threshold. The multi stage control may further include operating one or more of the A/C unit 112, the heat pump, or the blower 116 at a second power level and/or speed lower than the first power level and/or speed in response to the difference between the primary temperature and the primary setpoint being less than the first threshold but greater than a second threshold. The multi stage control may further include turning one or more of the A/C unit 112, the heat pump, or the blower 116 off in response to the difference between the primary temperature and the primary setpoint being less than the second threshold.

Optionally, in an aspect, the controller 140 may perform the secondary temperature control 109 based on the one or more secondary temperature measurements by calculating a secondary temperature as a function of the one or more secondary temperature measurements received after a period of time, for example, after one or ten minutes has passed since starting the primary temperature control 108. The controller 140 may further compare the secondary temperature with a secondary setpoint. The controller 140 may further perform a secondary control of one or more of the furnace 114, the A/C unit 112, a heat pump, or the blower 116 based on the comparing.

Optionally, in an aspect, the controller 140 may calculate the secondary temperature as an average of the one or more secondary temperature measurements.

Optionally, in an aspect, the controller 140 may perform the secondary control by performing a single stage control.

In an aspect, for example, the single stage control may include turning one or more of the furnace 114, the heat pump, or the blower 116 on in response to the secondary temperature being less than the secondary setpoint beyond a low threshold. The single stage control may further include turning one or more of the furnace 114, the heat pump, or the blower 116 off in response to the secondary temperature being within a high threshold of the secondary setpoint.

In an alternative aspect, for example, the single stage control may include turning one or more of the A/C unit 112, the heat pump, or the blower 116 on in response to the secondary temperature being greater than the secondary setpoint beyond a high threshold. The single stage control may further include turning one or more of the A/C unit 112, the heat pump, or the blower 116 off in response to the secondary temperature being within a low threshold of the secondary setpoint.

Optionally, in an aspect, the controller 140 may perform the secondary control by performing a multi stage control.

In an aspect, for example, the multi stage control may include operating one or more of the furnace 114, the heat pump, or the blower 116 at a first power level and/or speed in response to a difference between the secondary temperature and the secondary setpoint being greater than a first threshold. The multi stage control may further include operating one or more of the furnace 114, the heat pump, or the blower 116 at a second power level and/or speed lower than the first power level or speed in response to the difference between the secondary temperature and the secondary setpoint being less than the first threshold but greater than a second threshold. The multi stage control may further include turning one or more of the furnace 114, the heat pump, or the blower 116 off in response to the difference between the secondary temperature and the secondary setpoint being less than the second threshold.

In an alternative aspect, for example, the multi stage control may include operating one or more of the A/C unit 112, the heat pump, or the blower 116 at a first power level and/or speed in response to a difference between the secondary temperature and the secondary setpoint being greater than a first threshold. The multi stage control may further include operating one or more of the A/C unit 112, the heat pump, or the blower 116 at a second power level and/or speed lower than the first power level and/or speed in response to the difference between the secondary temperature and the secondary setpoint being less than the first threshold but greater than a second threshold. The multi stage control may further include turning one or more of the A/C unit 112, the heat pump, or the blower 116 off in response to the difference between the secondary temperature and the secondary setpoint being less than the second threshold.

Optionally, in an aspect, the primary temperature sensor 104 or the one or more secondary temperature sensors 106 may each include a wired or wireless sensor.

Optionally, in an aspect, the primary temperature sensor 104 may be configured in a central location in a house or building, such as a living room on a multi-level house. Optionally, in an aspect, the one or more secondary temperature sensors 106 may be configured in one or more secondary locations in the house or building, such as a bedroom or basement in a multi-level house.

Optionally, in an aspect, the primary temperature sensor 104 may be configured in a main floor in a multi-level house. Optionally, in an aspect, the one or more secondary temperature sensors 106 may be configured in a lower floor or an upper floor relative to the main floor in the multi-level house. For example, in an aspect, during the day on the weekends, a temperature sensor in the living room of a multi-level house may be designated as the primary temperature sensor 106, and other temperature sensors in other areas of the house, such as the basement or the bedrooms, may be designated as secondary temperature sensors 106. However, in the evenings, a temperature sensor in the kitchen may be designated as the primary temperature sensor 106, and other temperature sensors in other areas such as the living room, the basement, or the bedrooms may be designated as secondary temperature sensors 106, since the kitchen is where the house occupants are most likely to be in the evening. Similarly, at night, a temperature sensor in a bedroom may be designated as the primary temperature sensor 106, and other temperature sensors in other areas such as the living room, the kitchen, or the basement may be designated as secondary temperature sensors 106.

Optionally, in an aspect, the controller 140 may receive occupancy information associated with a location of a sensor, and in response select the sensor as the primary temperature sensor 104. For example, in an aspect, the controller 140 may receive information indicating that an occupancy sensor in the living room of a house is activated, and in response select a temperature sensor in the living room to be the primary temperature sensor 104.

Optionally, in an aspect, the controller 140 may receive occupancy information associated with one or more locations of one or more sensors, and in response select the one or more sensors as the one or more secondary temperature sensor 106. For example, in an aspect, the controller 140 may receive information indicating that occupancy sensors in the bedroom and in the basement of a house are activated, and in response select the temperature sensors in the basement and the bedroom to be the one or more secondary temperature sensors 106. In this aspect, the controller 140 may select the primary temperature sensor 104 based on a user setting, and then use occupancy information for selecting the one or more secondary temperature sensors 106.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A temperature control apparatus, comprising:
a processor; and
a memory coupled with the processor and storing instructions that, when executed by the processor, cause the processor to:
receive, from a remote user device associated with a user, a user designation designating a temperature sensor from among a plurality of temperature sensors;
select, in response to receiving the user designation, the temperature sensor as a primary temperature sensor for controlling an ambient condition;
receive a primary temperature measurement from the primary temperature sensor; and
perform a primary temperature control based on the primary temperature measurement.

2. The temperature control apparatus of claim 1, wherein the instructions, when executed by the processor, further cause the processor to:
receive secondary temperature measurements from secondary temperature sensors; and
perform a secondary temperature control based on the secondary temperature measurements.

3. The temperature control apparatus of claim 2, wherein the instructions, when executed by the processor, further cause the processor to:
receive current timing information for performing the primary temperature control, wherein selection of the primary temperature sensor is further based on the current timing information.

4. The temperature control apparatus of claim 3, wherein the current timing information comprises at least one of a current time of day or a current day of week.

5. The temperature control apparatus of claim 2, wherein the processor performs the primary temperature control based on the primary temperature measurement by:
comparing the primary temperature measurement with a primary setpoint; and
performing a single stage control of one or more of a furnace, an air conditioner (A/C) unit, a heat pump, or a blower based on the comparing.

6. The temperature control apparatus of claim 5, wherein the processor performs the single stage control by:
turning one or more of the furnace or the blower on in response to the primary temperature measurement being less than the primary setpoint beyond a low threshold; and
turning one or more of the furnace or the blower off in response to the primary temperature measurement being within a high threshold of the primary setpoint.

7. The temperature control apparatus of claim 5, wherein the processor performs the single stage control by:
turning one or more of the A/C unit, the heat pump, or the blower on in response to the primary temperature measurement being greater than the primary setpoint beyond a high threshold; and
turning one or more of the A/C unit, the heat pump, or the blower off in response to the primary temperature measurement being within a low threshold of the primary setpoint.

8. The temperature control apparatus of claim 2, wherein the processor performs the secondary temperature control based on the secondary temperature measurements by:
calculating a secondary temperature as a function of the secondary temperature measurements received after a period of time;
comparing the secondary temperature with a secondary setpoint; and
performing a secondary control of one or more of a furnace, an air conditioner (A/C) unit, a heat pump, or a blower based on the comparing.

9. The temperature control apparatus of claim 8, wherein the processor calculates the secondary temperature as an average of the secondary temperature measurements.

10. The temperature control apparatus of claim 8, wherein the processor performs the secondary control by performing a single stage control, including:
turning one or more of the furnace, the heat pump, or the blower on in response to the secondary temperature being less than the secondary setpoint beyond a low threshold; and
turning one or more of the furnace, the heat pump, or the blower off in response to the secondary temperature being within a high threshold of the secondary setpoint.

11. The temperature control apparatus of claim 8, wherein the processor performs the secondary control by performing a single stage control, including:
turning one or more of the A/C unit, the heat pump, or the blower on in response to the secondary temperature being greater than the secondary setpoint beyond a high threshold; and
turning one or more of the A/C unit, the heat pump, or the blower off in response to the secondary temperature being within a low threshold of the secondary setpoint.

12. The temperature control apparatus of claim 8, wherein the processor performs the secondary control by performing a multi stage control, including:
operating one or more of the furnace, the heat pump, or the blower at a first power level or speed in response to a difference between the secondary temperature and the secondary setpoint being greater than a first threshold;
operating one or more of the furnace, the heat pump, or the blower at a second power level or speed lower than the first power level or speed in response to the difference between the secondary temperature and the secondary setpoint being less than the first threshold but greater than a second threshold; and
turning one or more of the furnace, the heat pump, or the blower off in response to the difference between the secondary temperature and the secondary setpoint being less than the second threshold.

13. The temperature control apparatus of claim 8, wherein the processor performs the secondary control by performing a multi stage control, including:
operating one or more of the A/C unit, the heat pump, or the blower at a first power level or speed in response to a difference between the secondary temperature and the secondary setpoint being greater than a first threshold;
operating one or more of the A/C unit, the heat pump, or the blower at a second power level or speed lower than the first power level or speed in response to the difference between the secondary temperature and the secondary setpoint being less than the first threshold but greater than a second threshold; and
turning one or more of the A/C unit, the heat pump, or the blower off in response to the difference between the secondary temperature and the secondary setpoint being less than the second threshold.

14. The temperature control apparatus of claim 2, wherein the primary temperature sensor comprises a primary wired or wireless sensor, wherein the secondary temperature sensors comprise a secondary wired or wireless sensor.

15. The temperature control apparatus of claim 2, wherein the primary temperature sensor is configured in a central location in a house or building, wherein the secondary temperature sensors are configured in secondary locations in the house or building.

16. The temperature control apparatus of claim 2, wherein the primary temperature sensor is configured in a main floor in a multi-level house, wherein the secondary temperature sensors are configured in a lower floor or an upper floor relative to the main floor in the multi-level house.

17. The temperature control apparatus of claim 2, wherein the instructions, when executed by the processor, further cause the processor to:
receive occupancy information associated with a location of a sensor; and
select the sensor as the primary temperature sensor.

18. The temperature control apparatus of claim 2, wherein the instructions, when executed by the processor, further cause the processor to:
receive occupancy information associated with a location of a sensor; and
select the sensor as one of the secondary temperature sensors.

19. The temperature control apparatus of claim 1, wherein the instructions, when executed by the processor, cause the processor to receive the user designation from an application on the remote user device associated with the user.

20. The temperature control apparatus of claim 19, wherein the application is configured to allow the user associated with the remote user device to control an operation of the temperature control apparatus.

21. The temperature control apparatus of claim 20, wherein the operation comprises a heating, ventilation, and air conditioning (HVAC) operation.

22. The temperature control apparatus of claim 20, wherein the application is configured to communicate with a controller of the temperature control apparatus to allow the user associated with the remote user device to control the operation of the temperature control apparatus.

23. A temperature control method, comprising:
receiving, from a remote user device associated with a user, a user designation designating a temperature sensor from among a plurality of temperature sensors;
selecting, in response to receiving the user designation, the temperature sensor as a primary temperature sensor for controlling an ambient condition;
receiving a primary temperature measurement from the primary temperature sensor; and
performing a primary temperature control based on the primary temperature measurement.

24. A non-transitory computer-readable medium storing instructions that, when executed by a processor, cause the processor to perform temperature control by:
receiving, from a remote user device associated with a user, a user designation designating a temperature sensor from among a plurality of temperature sensors;
selecting, in response to receiving the user designation, the temperature sensor as a primary temperature sensor for controlling an ambient condition;
receiving a primary temperature measurement from the primary temperature sensor; and
performing a primary temperature control based on the primary temperature measurement.
